(19) United States
(12) Patent Application Publication
(10) Pub. No.: US 2016/0073658 A1
(43) Pub. Date: Mar. 17, 2016

(54) PET CHEW ARTICLES AND METHODS OF MANUFACTURE

(71) Applicant: HIMALAYAN CORPORATION, Mukilteo, WA (US)

(72) Inventors: SUMAN K. SHRESTHA, Marysville, WA (US); SUJAN K. SHRESTHA, Marysville, WA (US); NISHES SHRESTHA, Everett, WA (US)

(21) Appl. No.: 14/950,386

(22) Filed: Nov. 24, 2015

Related U.S. Application Data
(62) Division of application No. 13/858,592, filed on Apr. 8, 2013.
(60) Provisional application No. 61/622,084, filed on Apr. 10, 2012.

(51) Int. Cl. A23K 1/00; A23K 1/08; A23K 1/18; A23K 1/10

(52) U.S. Cl. CPC A23K 1/001; A23K 1/10; A23K 1/08; A23K 1/1853

(57) ABSTRACT

Pet chew products and methods of manufacturing such products are disclosed. Some pet chew products may comprise puffed pieces of dry animal tissue, such as bully stick, or puffed pieces of hardened cheese, such as hardened yak cheese made for pet consumption. Some pet chew products may comprise hardened cheese, dry animal tissue such as a bully stick, and a sugar protein bond joining the hardened cheese and the dry animal tissue.

### CROSS-REFERENCE TO RELATED APPLICATIONS

This application is a divisional which claims priority under 35 U.S.C. §121 of U.S. patent application Ser. No. 13/858,592, entitled “PET CHEW ARTICLES AND METHODS OF MANUFACTURE”, filed on Apr. 8, 2013, which is a nonprovisional claiming priority under 35 U.S.C. §119 to U.S. Provisional Application No. 61/622,084, entitled “PET CHEW ARTICLES AND METHODS OF MANUFACTURE”, filed on Apr. 10, 2012.

Furthermore, U.S. patent application Ser. No. 14/602,952, filed on Jan. 22, 2015, and U.S. patent application Ser. No. 13/858,592, filed on Apr. 8, 2013, both also entitled “PET CHEW ARTICLES AND METHODS OF MANUFACTURE”, are related by subject matter. The parent and related applications are incorporated by reference.

### BACKGROUND

There are a variety of popular pet chew products available in pet supply stores, including so-called “bully sticks” and hard cheese based pet chews. Himalayan Dog Chews, referred to herein as HDC, are one example of hardened cheese pet chews generally made of yak or cow milk, imported from Nepal and distributed in the United States by the Himalayan Corporation. There is an ongoing need to increase the variety of pet chew products to meet the needs and preferences available to dog and other pet owners.

### SUMMARY

Pet chew products and methods of manufacturing such products are disclosed. Some example pet chew products may comprise a puffed piece of dry animal tissue or a puffed piece of hardened cheese, e.g., a puffed piece of bully stick or other dry animal tissue comprising dried corpus cavernosum and/or dried corpus spongiosum type tissue, or a puffed piece of hardened cheese comprising cheese that is initially strongly resistant or impossible to cut by hand with a knife. The puffed piece may be puffed by initiation of heat generally equally throughout an unpuffed piece of dry animal tissue, or hardened cheese, effective to convert moisture therein into steam and to produce an outward force on tissue molecules inside the unpuffed piece. The initiation of heat may be effective to reduce the overall weight of the unpuffed piece and to alter the texture thereof, imparting to the resulting puffed piece of dry animal tissue, or puffed piece of hardened cheese, a lighter weight and different texture than the unpuffed piece.

Some example pet chew products may comprise hardened cheese, e.g., cheese that is strongly resistant or impossible to cut by hand with a knife, dry animal tissue such as a bully stick comprising one or more of dried corpus cavernosum or dried corpus spongiosum type tissue, and a sugar protein bond joining the hardened cheese and the dry animal tissue, wherein the bond is resistant to separation of the hardened cheese and dry animal tissue. For example, a bully stick may be inserted into a hole in the hardened cheese or wrapped with slices of the hardened cheese. Methods for manufacturing such pet chew products may include boiling a piece of hardened cheese; engaging a surface of the resulting hot expanded cheese to a surface of the dry animal tissue, such as by inserting a bully stick in a hole drilled in the hardened cheese, or wrapping the bully stick with slices of the hot expanded cheese; and cooling the hot expanded cheese while maintaining the engagement with the dry animal tissue to form the sugar protein bond. Further aspects and embodiment are described in detail below.

### BRIEF DESCRIPTION OF THE DRAWINGS

Various features and attendant advantages of the disclosed technologies will become fully appreciated when considered in conjunction with the accompanying drawings, in which like reference characters designate the same or similar parts throughout the several views, and wherein:

FIG. 1 illustrates a bully puff pet chew product resulting from applying the methods disclosed herein to processed bully stick pet chew products;

FIG. 2 illustrates a starting material for manufacturing the bully puff pet chew product illustrated in FIG. 1;

FIG. 3 illustrates a cross section of a bully stick pet chew product;

FIG. 4 illustrates general heating methods;

FIG. 5 illustrates microwave heating methods that may be applied to processed bully stick pet chew products;

FIG. 6 illustrates an average sized block of hardened cheese;

FIG. 7 illustrates a cut piece of hardened cheese;

FIG. 8 illustrates a puffed piece of hardened cheese;

FIG. 9 illustrates a drilled piece of hardened cheese;

FIG. 10 illustrates boiling pieces of hardened cheese;

FIG. 11 illustrates insertion of a bully stick into a drilled, heated piece of hardened cheese;

FIG. 12 illustrates a pet chew product configuration with bully stick protruding from hardened cheese;

FIG. 13 illustrates a pet chew product configuration with bully stick inside a block of hardened cheese;

FIG. 14 illustrates a “shish kebab” pet chew product configuration with a series of hardened cheese blocks spaced along a single bully stick; and

FIGS. 15A, 15B, and 15C illustrate a pet chew product configuration with one or more slices of hardened cheese wrapped around a bully stick.

### DETAILED DESCRIPTION

Prior to explaining embodiments of the invention in detail, it is to be understood that this disclosure is not limited to the details of construction or arrangements of the components and method steps set forth in the following description or illustrated in the drawings. Embodiments of this disclosure are capable of other embodiments and of being practiced and carried out in various ways. Also, it is to be understood that the phraseology and terminology employed herein are for the purpose of the description and should not be regarded as limiting.

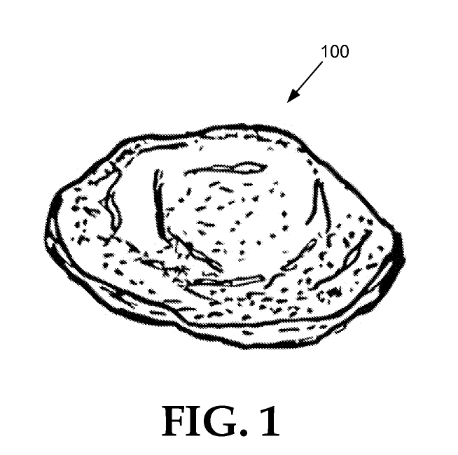

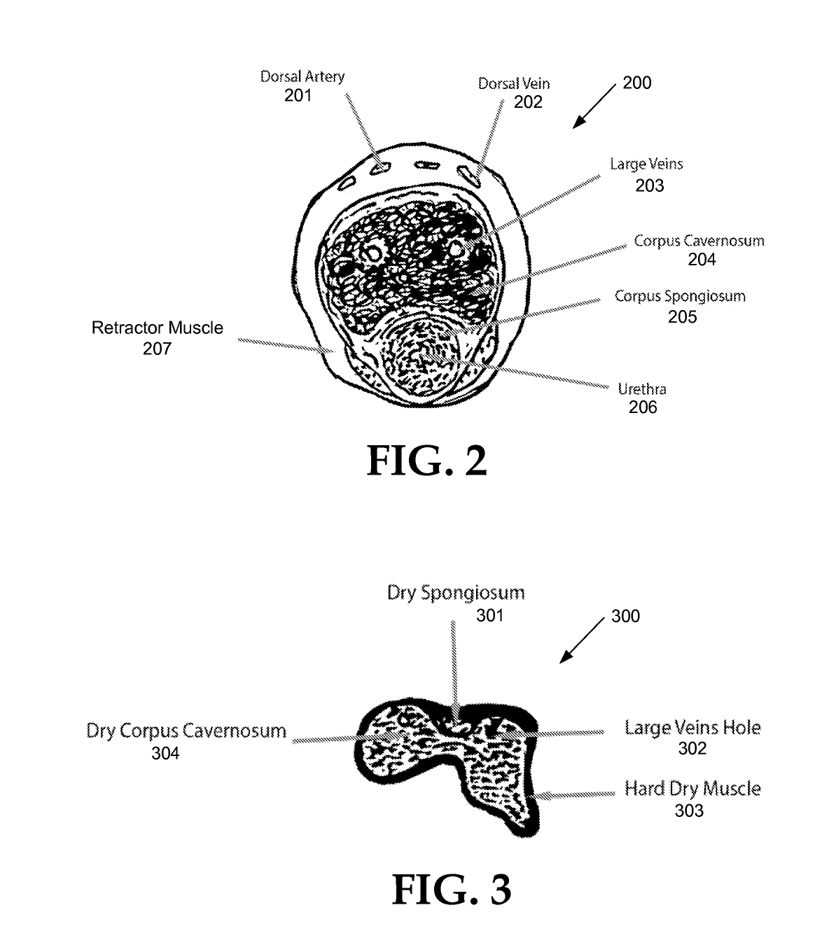

In a first embodiment, a “bully puff”, or puffed pet chew product made from bully sticks, is disclosed. FIG. 1 illustrates an example bully puff pet chew product 100. Bully puff pet chew product 100 may weigh about 0.3 grams to about 35 grams and may generally comprise a dry, foamy, crumbly material resulting from processing appropriately prepared bully stick pieces as disclosed herein. Bully puff pet chew product 100 may be produced by applying the methods disclosed herein to processed bully stick pet chew products. FIG. 2-FIG. 4 generally illustrate processing steps for methods of producing bully sticks and bully puff pet chew products such as 100.

FIG. 2 illustrates a starting material for manufacturing bully sticks, which bully sticks are an example of dry tissue which may be subsequently used to make bully puff pet chew products illustrated in FIG. 1, or other puffed pet chew products made from dry animal tissue. Bully Sticks are also known as pizzles, and may generally comprise the dried penis, or segment thereof, of an animal, especially but not limited to bull. FIG. 2 illustrates a cross section 200 of a bull penis, which may be processed to make a bully stick. Cross section 200 includes dorsal artery 201, dorsal vein 202, large veins 203, corpus cavernosum 204, corpus spongiosum 205, urethra 206, and retractor muscle 207. Bully sticks generally comprise hard, dry sticks of fibrous muscle tissue comprising dried corpus cavernosum and dried corpus spongiosum type tissue. Bully sticks may be prepared by cleaning, stretching, twisting and then drying. Initial processing may include drying by the sun drying method, oven baking method, and/or smoking method in a traditional or other smoker. The result is a hard and typically 30-40 inches long brown bully stick which may then be sawed into pieces of any desired lengths, as appropriate for different sizes of dogs. The pieces are typically “stick” shaped, that is, long and thin relative to their length, such as, for example, 10 inches long and one half inch in diameter.

FIG. 3 illustrates a cross section 300 of a bully stick pet chew product. Cross section 300 generally includes the elements illustrated in FIG. 2, in a dried and hardened state achieved through processing. For example, cross section 300 includes dry corpus spongiosum type tissue 301, a large veins hole 302, hard dry muscle 303, and dry corpus cavernosum type tissue 304.

In some embodiments, after initial processing to produce a bully stick or other dry tissue product, the dried tissue may be processed as follows to produce puffed pet chew products 100:

1. The bully stick may be cut into pieces ranging from about 0.3 grams to about 35 grams. These pieces may be referred to herein as unpuffed pieces of dry animal tissue.

2. The texture of these pieces may be further dried, or softened by steaming or soaking, to achieve a desired texture that is hard, dry, chewy and in between malleable and brittle.

3. The pieces may be heated in a microwave oven for anywhere from about 1 second to about 3 minutes per piece, or in some embodiments, from about 15 seconds to about 3 minutes per piece depending on the average size of the pieces and power of the microwave.

4. The result is puffed puff pet chew products 100, also referred to herein as puffed pieces of dry animal tissue, which may be, e.g., about 2 to about 4 times the size of the starting unpuffed pieces of dry animal tissue. The texture of the puffed pet chew products 100 is dry and foamy and nature may be crumbly.

It will be appreciated that variations of the above process may be possible. Any variations effective to produce a bully puff product 100 are within the spirit and scope of this disclosure, as are any resulting bully puff products. The term “puffed” generally refers to swollen and/or dilated from an original size.

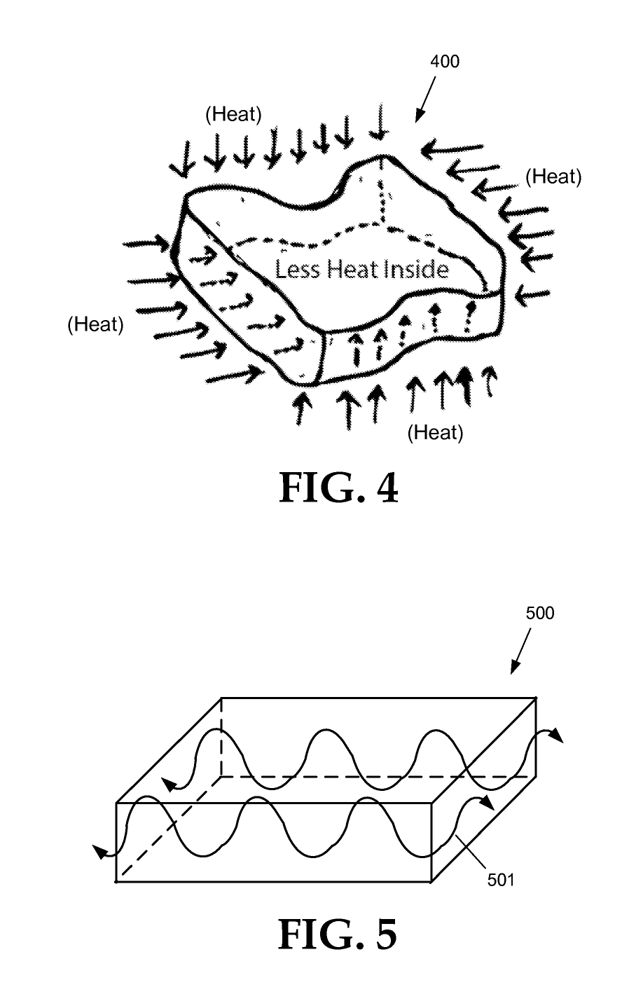

FIG. 4 illustrates general heating methods applied to an unpuffed piece of dry animal tissue 400, such as an unpuffed piece of bully stick. The moisture in the dry hard tissue of a bully stick is low. Applying heat to the exterior of the piece 400, by methods such as in conventional ovens, popcorn machines or frying pans, will generally not effectively puff the tissue, but instead will burn the tissue. The reason is, in such general methods of heating the heat radiates from outer surface to inner, resulting in less heat inside the piece 400 than at the outer surface. Hence, before there is enough heat for the moisture to turn into steam in the inside the piece 400, the outer surface of the piece 400 gets more heat than the inside. This may result in burning the tissue at the outer surface of piece 400.

FIG. 5 illustrates microwave heating methods that may be applied to an unpuffed piece of dry animal tissue 500, such as an unpuffed bully stick pet chew product which has been initially processed, or pre-processed, according to the methods contemplated herein. Microwaves 501 may be applied to piece 500 to generate sufficient heat inside piece 500 to puff the piece 500. Bully stick tissue contains a certain amount of water activity (average of less than 10%). When heated in a microwave oven this moisture converts into steam and comes outward, pushing the tissue molecules inside piece 500 in all directions with puffing sound. This puffing or popping of the molecules changes the nature and texture of the original piece 500 into a bully puff pet chew product such as 100. Since the moisture from the original piece 500 is substantially lost through the puffing process, the overall weight of the bully puff pet chew product 100 may be less than that of the piece 500 by about 4-10%.

In the microwave the wave energy penetrates the tissue piece 500 from all directions, thereby initiating the heat generally equally throughout piece 500. The moisture in the inside of piece 500 is heated to steam before there is enough heat at the surface of piece 500 to burn the surface molecules, and hence the steam escapes out with a popping sound, pushing the tissue molecule in all directions. While microwave heating is disclosed herein as a preferred embodiment, it is appreciated that other heating methods may be effective to produce the puffing effect by relying upon the teachings provided herein, namely, by applying heating methods according to FIG. 5 and equivalents thereof, which heat from the inside out, or at least more evenly throughout than methods according to FIG. 4, which apply heat at the outer surface of a piece.

In some embodiments, any animal's dried pizzles, dried tendons , dried scrotum or other dried tissue that contains “corpus cavernosum” or “corpus spongiosum”' (referred to collectively referred to as dry tissue) may be processed according to the techniques provided herein to produce puffed pet chew products. Also, in some embodiments, dried cartilage (including fish cartilage), dried smooth muscle (including vascular smooth muscle) may be processed according to the techniques provided herein to produce puffed pet chew products.

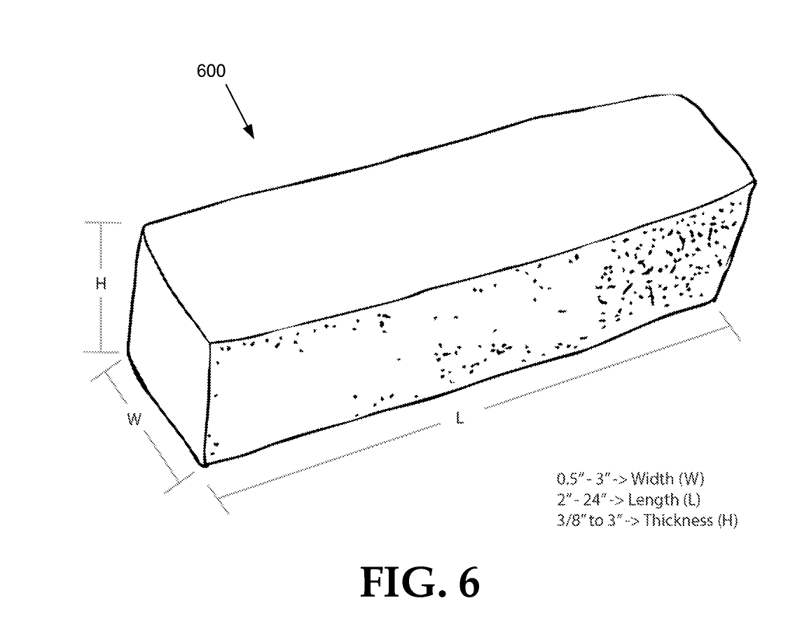

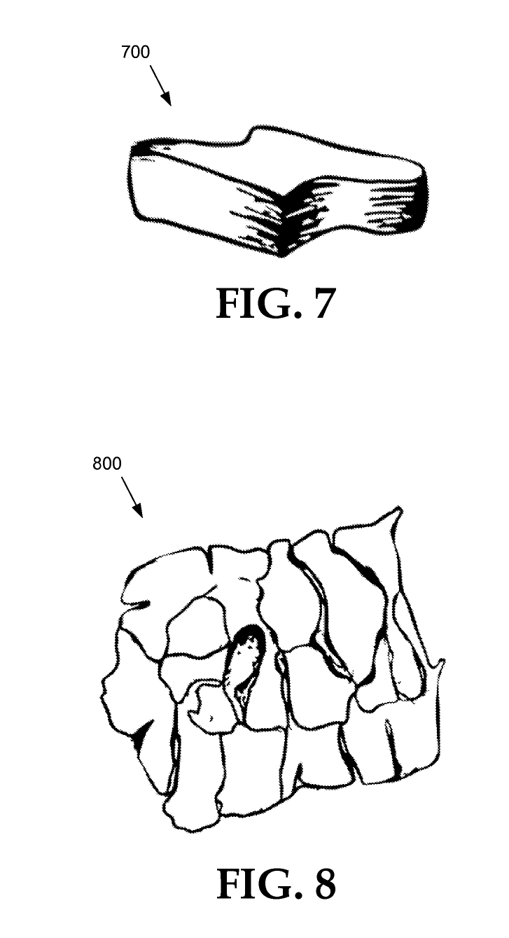

In a second embodiment, a “yaky puff”, or puffed pet chew product made from hardened cheese, such as HDC or other similar hardened cheese, is disclosed, along with methods for making the same. FIG. 6-FIG. 8 illustrate an example yaky puff pet chew product and method for making same. FIG. 8 illustrates a yaky puff 800, which may be produced as described in connection with FIG. 6-FIG. 7, all of which may be further understood with reference to the teachings of FIG. 1-FIG. 5.

FIG. 6 illustrates an average sized piece of hardened cheese 600. Hardened cheese 600 may have a width of about 0.5 inches, a length in the range of about 2 inches to about 24 inches, and a thickness (or height) in the range of about ⅜ inches to about 3 inches. Hardened cheese 600 may comprise HDC, known in the pet supply industry as a kind of hard cheese made of yak, cow, or other mammal milk, currently imported from Nepal and distributed in the United States by Himalayan Corporation.

The following process, and equivalents thereof, may be applied to make hardened cheese 600. Milk may be coagulated into cheese by treating with lime juice and salt. Coagulated cheese may be packed in burlap sacks which may be used as cheese cloth. This packed cheese may then be pressed for about several days to remove the moisture. After about 6-7 days, the burlap may be unwrapped and the cheese block may be taken out. This block may be cut into several rectangular pieces which may range anywhere from about 0.5 inches to about 3.0 inches thick and about 2 inches to about 24 inches long. The cut rectangular pieces may then be sun dried and/or smoked consecutively for about 4-5 months. The result is rock hard yellowish to dark brown colored cheese, such as hardened cheese 600, generally appropriate for dog and other pet consumption.

In some embodiments, a block of hardened cheese 600 may be processed as follows:

1. Hardened cheese 600 may be sawed into small pieces, of weight ranging from about 1 gram to about 45 grams. An example piece 700 is illustrated in FIG. 7. Piece 700 may be allowed to dry further as needed to impart a texture of piece 700 that may be hard, dry and brittle.

2. Pieces such as 700 may be heated in a microwave oven for anywhere from about 1 second to about 3 minutes per piece, or in some embodiments, from about 15 seconds to about 3 minutes per piece, depending on the average size of the pieces and power of the microwave.

3. The result is puffed pet chew products such as yaky puff 800, illustrated in FIG. 8. Yaky puff 800 may be about 3 to about 5 times the original size of piece 700. The texture of the yaky puff 800 may be dry and foamy, and nature may be crumbly.

It will be appreciated that variations of the above process may be possible. Any variations effective to produce a yaky puff product 800 are within the spirit and scope of this disclosure, as are any resulting yaky puff products.

Referring again to FIG. 4, general heating methods are generally ineffective to produce the results disclosed herein. The moisture in piece 700 is low and applying heat to it by other methods such as in conventional ovens, popcorn machines or frying pans will generally not puff or pop the piece 700, but instead the piece 700 may burn. The reason is, in such general methods of heating the heat radiates from outer surface to inner. Hence, before there is enough heat for the moisture to turn into steam in the inside of the HDC, the outer surface gets more heat than the inside. This burns the cheese.

Referring again to FIG. 5, microwave heating methods may be applied to processed piece 700, according to the processing methods contemplated herein. Hardened cheese in piece 700 may contain a certain amount of water activity (average of less than 5%). When heated in a microwave oven this moisture converts into steam and comes outward, pushing the cheese molecules in all directions with puffing sound. This puffing or popping of the molecule changes the nature and texture of the original piece. Since the moisture from the original piece 700 is substantially lost, the overall weight of the puffed product 800 may be less by about 5-12% than that of the original piece 700.

In the microwave the wave energy penetrates the cheese piece 700 from all directions, thereby initiating the heat generally equally. The moisture in the inside of piece 700 is heated to steam before there is enough heat is initiated to burn the molecules at the outer surface of piece 700, and hence the steam escapes out with popping sound, pushing the cheese molecules in all directions. While microwave heating is disclosed herein as a preferred embodiment, it is appreciated that other heating methods may be effective to produce the puffing effect by relying upon the teachings provided herein.

In some embodiments, any hard cheese, e.g., cheese hard enough to require a band saw or similar type of equipment to cut into pieces, and hard enough to offer strong resistance to being cut by hand with a knife, or impossible to cut by hand with a knife, may be processed according to the techniques provided herein.

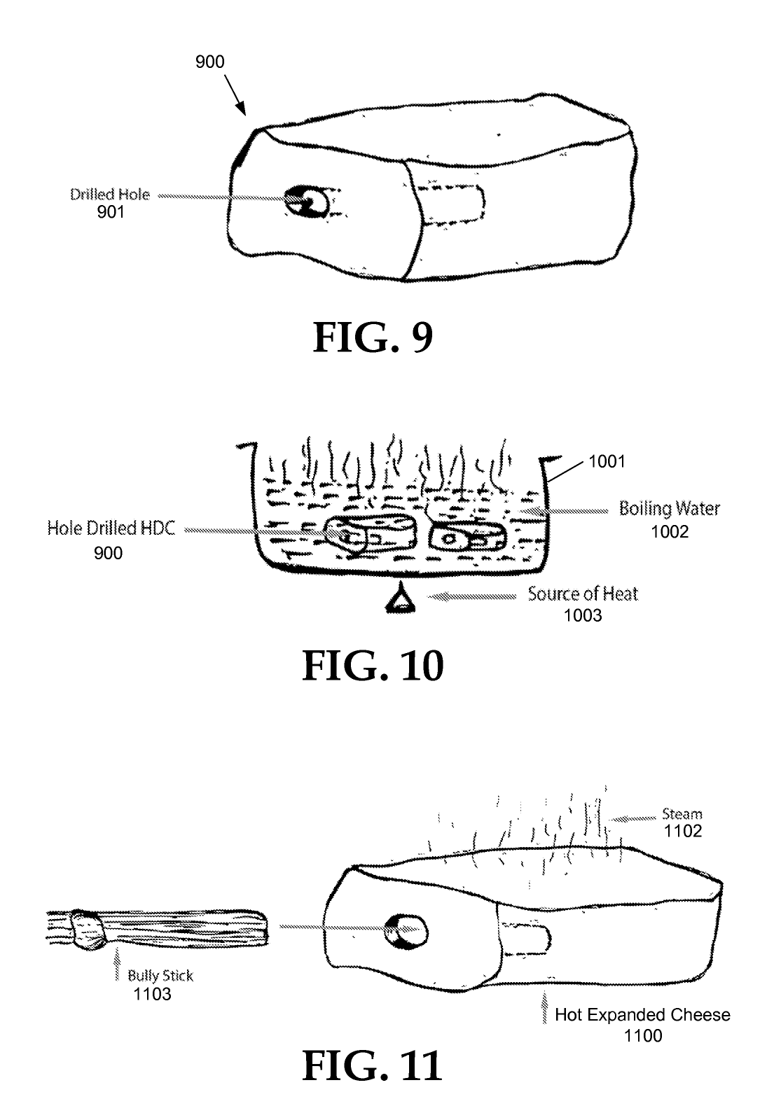

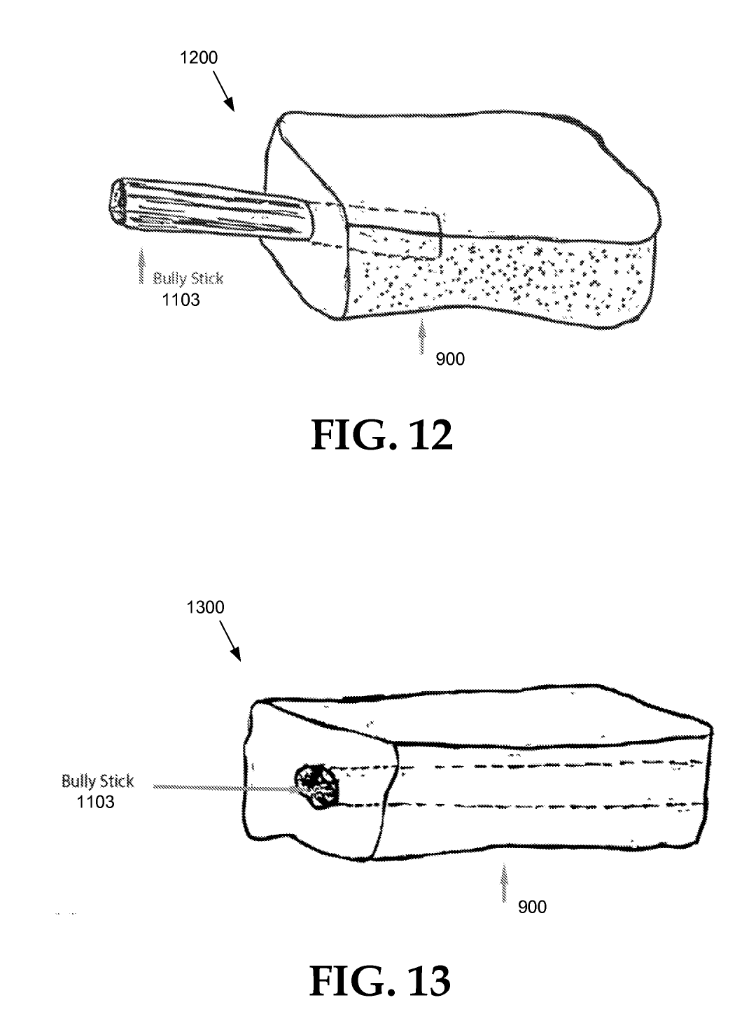

In a third embodiment, a “yaky stick”, or pet chew product made from a combination of dry tissue, such as bully sticks, and hardened cheese, is disclosed, along with methods for making the same. In general, when a bully stick is inserted inside a boiled or otherwise heated hardened cheese such as HDC, then the result may form a strong bond between the cheese molecules in the hardened cheese, and the tissue molecules in the bully stick. Bonded dry tissue/hardened cheese formations can be shaped and sized in many different ways for pet consumption. In some embodiments, a large fraction (such as about ⅕ or more) of the surface area of the bully stick may be placed in bonded contact with hardened cheese, resulting in a product that is chewable over time while resisting separation of the hardened cheese and bully stick. FIG. 9-FIG. 14 illustrate example yaky stick pet chew products and methods for making same. FIGS. 12, 13, and 14 illustrate different yaky stick configurations 1200, 1300, and 1400, respectively, each of which may be produced as described in connection with FIG. 9-FIG. 11.

FIG. 9-FIG. 11 illustrate example processing steps. In some embodiments, a block of hardened cheese 900 and bully stick 1103 may be processed as follows:

1. A hole may be drilled inside of any shape and size of hardened cheese 900 to insert any shape and size bully stick. FIG. 9 illustrates a drilled hole 901 in a piece of hardened cheese 900. Drilled hole 901 may be smaller in diameter than bully stick 1103. Drilled hole 901 is defined by a surface which comprises an internal surface of the hardened cheese 900.

2. The drilled hardened cheese 900 may be placed in boiling water until it gets soft and malleable, which state is referred to as hot expanded cheese 1100. FIG. 10 illustrates pieces of hardened cheese 900 in boiling water 1002, all in a container 1001 over a source of heat 1003 sufficient to boil the water.

3. The hot expanded cheese 1100 may then be taken out from the boiling water 1002, and a surface of the hot expanded cheese may be engaged, that is, placed in contact with, a surface of the dry animal tissue. In the illustrated example, a bully stick 1103 may be substantially immediately inserted into the hole 901 to engage the surfaces, while the hot expanded cheese 1100 is still hot and steamy. FIG. 11 illustrates insertion of a bully stick 1103 into hot expanded cheese 1100, while hot expanded cheese 1100 remains sufficiently hot to give off steam 1102 at room temperature. Bully stick 1103 may be inserted into hole 901 for example by manually pushing hard on bully stick 1103 to drive an end of bully stick 1103 to the bottom of the drilled hole 901.

4. The new formed structure may be cooled off in room temperature for a minimum of about 20 minutes, while maintaining the engagement between the dry animal tissue, e.g., the bully stick, and the hardened cheese to form a sugar protein bond joining the hardened cheese and the dry animal tissue. The result is a strong bonded structure between the hardened cheese 900 and the dry animal tissue 1103. The bond may be sufficiently strong to resist separation of the hardened cheese and dry animal tissue, e.g., when the yaky stick is chewed by a dog.

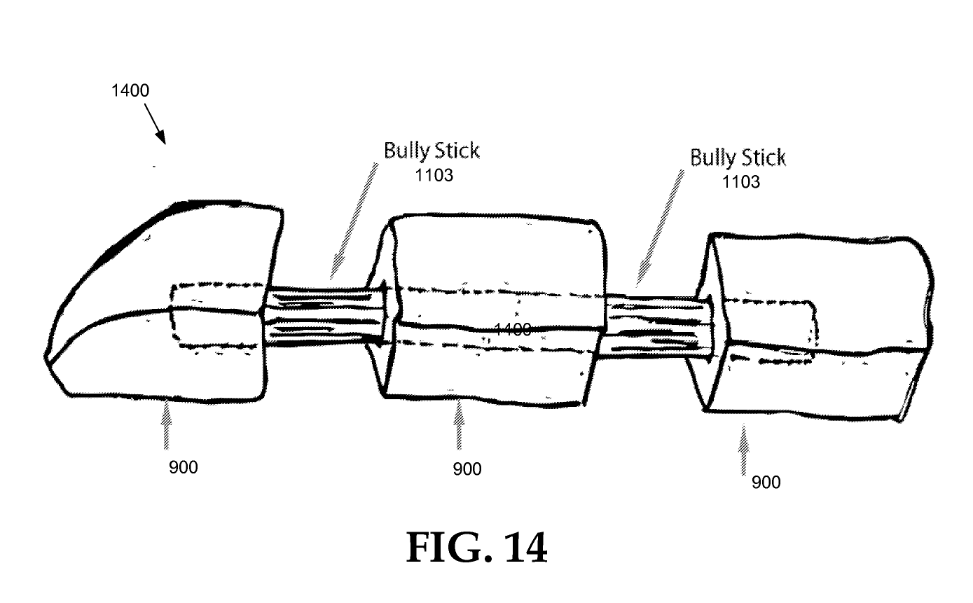

FIG. 9-FIG. 11 may be applied to produce any desired structure. FIG. 12, FIG. 13, and FIG. 14 illustrated example yaky stick structures which may be produced in some embodiments. FIG. 12 illustrates a drum stick configuration 1200 with bully stick 1103 protruding from hardened cheese 900. FIG. 13 illustrates a configuration 1300 with bully stick 1103 inside a block of hardened cheese 900. FIG. 14 illustrates “shish kebab” configuration 1400 with a series of hardened cheese 900 blocks spaced along a single bully stick 1103. It will be appreciated that structures of any other desired shape and size may be achieved.

It will be appreciated that variations of the above process may be possible. Any variations effective to produce a yaky stick product are within the spirit and scope of this disclosure, as are any resulting yaky stick products. For example, it should be appreciated that similar results may be achieved by boiling the bully stick or other dry tissue as defined herein, and inserting hard cheese in it or wrapping hardened cheese around it. Both hardened cheese and dry tissue may be boiled in some embodiments. Also, heating methods other than boiling may be appropriate in some embodiments. Although the diameter of the bully stick and the hole in the hardened cheese may be similar in diameter, they may also be of different diameters in some embodiments.

Hardened cheese contains sugar called lactose or broken lactose sugars such as galactose and glucose. When hardened cheese is boiled these sugars on the surface become slimy and sticky. The boiling water also expands the hardened cheese in all directions as it becomes soft and malleable. Similarly, the dry animal tissue contains dry protein membrane on its surface, which when moisture and heat is introduced, gets slimy and sticky. When dry tissue is inserted in a small drilled hole on the boiled steamy hardened cheese, the moisture and heat from the steam of boiled hardened cheese makes the protein membrane of the bully stick slimy and sticky. This slimy and sticky protein membrane of the dry animal tissue becomes effectively glued with the slimy and sticky sugar on the inner surface of the drilled hole of the hardened cheese, creating a strong sugar protein bond. As the new formed yaky stick structure is cooled off, the hole where the bully stick is pushed and inserted contracts and tightly holds the bully stick, thereby creating a strong bond between sugar and protein components.

A similar kind of bond may be achieved when any dry tissue, such as (but not limited to) trachea tissue, is boiled and hard cheese is inserted in it or dry smooth muscle tissue (including vascular smooth muscle tissue) is boiled and hardened cheese is wrapped in it. Therefore, it will be appreciated that in some embodiments, any animal's dried pizzles, dried tendons, or dried scrotum that contains “corpus cavernosum” or “corpus spongiosum” (referred to collectively referred to as dry tissue) may be processed according to the techniques provided herein to make yaky stick variants. Also, in some embodiments, dried cartilage (including fish cartilage), dried smooth muscle (including vascular smooth muscle) may be processed according to the techniques provided herein. Furthermore, in some embodiments, any hardened cheese, e.g., cheese hard enough to require a band saw or similar type of equipment to cut into pieces, may be processed according to the techniques provided herein to make yaky stick variants.

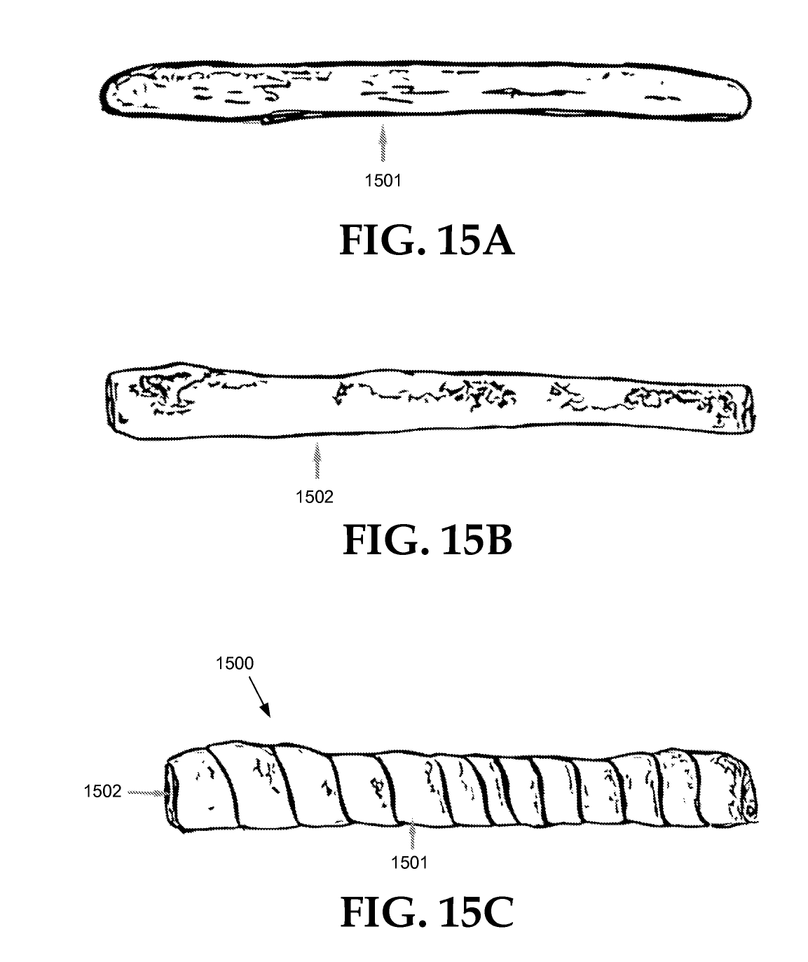

FIGS. 15A, 15B, and 15C illustrate another example yaky stick pet chew product and method for making same. FIG. 15C illustrates a yaky stick configuration 1500 which may be produced as described in connection with FIG. 15A-FIG. 15B. Yaky stick configuration 1500 may generally comprise dry tissue 1502, such as a bully stick, wrapped with one or more slices of hardened cheese 1501.

FIG. 15A-FIG. 15B illustrate example processing steps to produce yaky stick configuration 1500. In some embodiments, a one or more thin slices of hardened cheese 1501 may be cut, along with a bully stick 1502 of desired length. Hardened cheese 1501 may be boiled or otherwise heated as described in connection with FIG. 9-FIG. 13. When hardened cheese 1501 becomes soft and malleable, it may be wrapped around a portion of, up to the full length of bully stick 1502. Yaky stick configuration 1500 may be allowed to cool for the bond to set between hardened cheese 1501 and bully stick 1502 as described herein.

While various embodiments have been disclosed herein, other aspects and embodiments will be apparent to those skilled in art.

1-31. (canceled)

32. A method of manufacturing a pet chew product, comprising:
boiling a piece of hardened cheese, the hardened cheese comprising cheese that is impossible to cut by hand with a knife, to produce hot expanded cheese;
engaging a surface of the hot expanded cheese to a surface of a dry animal tissue comprising one or more of dried corpus cavernosum or dried corpus spongiosum type tissue; and
cooling the hot expanded cheese while maintaining the engagement with the dry animal tissue to form a bond joining the hardened cheese and the dry animal tissue, wherein the bond is resistant to separation of the hardened cheese and dry animal tissue.

33. A method according to claim 32 wherein the dry animal tissue comprises a bully stick.

34. A method according to claim 33, further comprising drilling a hole in the hardened cheese, and engaging the surface of the hot expanded cheese to the surface of the dry animal tissue comprises inserting the bully stick into the hole.

35. A method according to claim 33, further comprising cutting one or more slices of the hardened cheese and after boiling the slices, wrapping the hot expanded cheese slices around the bully stick.

36. A method according to claim 32 wherein engaging the surface of the hot expanded cheese to the surface of the dry animal tissue is done substantially immediately upon removing the hot expanded cheese from boiling water, while the hot expanded cheese is hot and steamy.

37. A method according to claim 32 wherein the cooling is done in room temperature for a minimum of about 20 minutes.
